(19) United States
(12) Patent Application Publication
(10) Pub. No.: US 2025/0153715 A1
(43) Pub. Date: May 15, 2025

(54) HIERARCHICAL BEHAVIOR LEARNING

(71) Applicant: TOYOTA MOTOR ENGINEERING & MANUFACTURING NORTH AMERICA, INC., Plano, TX (US)

(72) Inventors: SEYHAN UCAR, Mountain View, CA (US); Sachin Sharma, Kalamazoo, MI (US); Yongkang Liu, Mountain View, CA (US); Emrah Akin Sisbot, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI (JP)

(21) Appl. No.: 18/506,939

(22) Filed: Nov. 10, 2023

(51) Int. Cl. B60W 40/04; B60W 60/00

(52) U.S. Cl. CPC B60W 40/04; B60W 60/001; B60W 2554/402; B60W 2554/4046; B60W 2555/20

(57) ABSTRACT

Systems and methods are provided for multivariate hierarchical behavior learning of driving variabilities in anomalous driving detection. Examples include identifying first repetitive driving behavior and first contrasting driving behavior with respect to driving behavior in a first set of environmental conditions based on first vehicle data and identifying second repetitive driving behavior and second contrasting driving behavior with respect to driving behavior in a second set of environmental conditions based on second vehicle data. Examples also include detecting driving variabilities by comparing the second repetitive driving behavior and second contrasting driving behavior to the first repetitive driving behavior and first contrasting driving behavior to identify deviated driving behavior. Based on the detected driving variabilities, anomalous driving detection results from an anomalous driving detection model are updated.

### TECHNICAL FIELD

The present disclosure relates generally to systems and methods for traffic management and vehicular anomaly detection, and, more particularly, embodiments relate to driving behavior variability detection.

### DESCRIPTION OF RELATED ART

Traffic anomalies are driving actions, events, or situations that occur at an unusual location and/or an unusual time. Anomalies can adversely affect driving conditions and degrade driving performance. Anomalies can be either extrinsic anomalies, or intrinsic anomalies.

Extrinsic anomalies may be environmental anomalies. That is, extrinsic anomalies may be anomalies that are created by road or environmental conditions, such as potholes, lane closures, irregular road surfaces, inclement weather, and the like. Intrinsic anomalies may be driving anomalies. That is, intrinsic anomalies may be anomalies created by driving behavior, such as aggressive driving, drunk driving, distracted driving, and the like. Both intrinsic and extrinsic anomalies may cause unsafe driving environments that can lead to traffic accidents. As such, it may be desirable to detect anomalies and warn nearby drivers about detected anomalies so that these drivers may take the necessary precautions.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method is provided. The method comprises collecting first vehicle data of driving behavior of vehicles in a first set of environmental conditions and identifying first repetitive driving behavior and first contrasting driving behavior with respect to driving behavior in the first set of environmental conditions based on the first vehicle data. The method also comprises collecting second vehicle data of driving behavior of vehicles in a second set of environmental conditions and identifying second repetitive driving behavior and second contrasting driving behavior with respect to driving behavior in the second set of environmental conditions based on the second vehicle data. The method further comprises detecting one or more driving variabilities by comparing the second repetitive driving behavior and second contrasting driving behavior to the first repetitive driving behavior and first contrasting driving behavior to identify deviated driving behavior, and updating first anomalous driving detection results from an anomalous driving detection model based on the detected driving variabilities.

In another aspect, a hierarchical vehicular anomaly detection system is provided that comprises one or more manager devices, each manager device being associated with a certain geographic area, and an ego vehicle communicable connected to the one or more manager devices. The one or more manager devices is configured to execute instructions to collect first vehicle data of driving behavior of vehicles in a first set of environmental conditions; identify first repetitive driving behavior and first contrasting driving behavior with respect to driving behavior in the first set of environmental conditions based on the first vehicle data; collect second vehicle data of driving behavior of vehicles in a second set of environmental conditions; and identify second repetitive driving behavior and second contrasting driving behavior with respect to driving behavior in the second set of environmental conditions based on the second vehicle data. Further, one of the ego vehicle and the one or more manager devices is configured to execute instructions to detect one or more driving variabilities by comparing the second repetitive driving behavior and second contrasting driving behavior to the first repetitive driving behavior and first contrasting driving behavior to identify deviated driving behavior, and update first anomalous driving detection results from an anomalous driving detection model based on the detected driving variabilities.

In another aspect, a server is provided that comprises a memory storing instructions, and at least one processor communicably coupled to the memory. The at least one processor is configured to execute the instructions to detect a vehicle in a first set of environmental conditions and obtain first driving variability data for the first set of environmental conditions. The first set of environmental conditions comprises a first geographic area associated with the server and the first driving variability data is based on vehicle data of driving behavior of vehicles in the first set of environmental condition. The at least one processor is further configured to execute obtain second driving variability data for a second set of environmental conditions that differ from the first set of environmental conditions and identify one or more driving variabilities based on a comparison between the first and second driving variability data. The second driving variability data is based on vehicle data of driving behavior of vehicles in the second set of environmental condition. The at least one processor is also configured to operate the vehicle based on the identified one or more driving variabilities.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic block diagram of an example hierarchical vehicular anomaly detection system in accordance with embodiments disclosed herein.

FIG. 2 is a schematic representation of an example hybrid vehicle with which embodiments of the systems and methods disclosed herein may be implemented.

FIG. 3 illustrates an example architecture for anomaly detection in accordance with one embodiment of the systems and methods described herein.

FIG. 4 is a schematic diagram of an example manager of the hierarchical traffic management system of FIG. 1, in accordance with embodiments of the disclosed technology.

FIG. 5 is a flow chart illustrating example operations for identifying driving variabilities in accordance with various embodiments disclosed herein.

FIG. 6 depicts the hierarchical traffic management system of FIG. 1 identifying driving variabilities in accordance with embodiments disclosed herein.

FIG. 7 is a flow chart illustrating example operations for detection of anomalous driving behavior in accordance with various embodiments disclosed herein.

FIG. 8 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide for systems and method for multivariate hierarchical behavior learning of driving variabilities in anomalous driving detection. Driving variabilities refer to driving behaviors that can vary based on circumstance and/or environment. Anomalous driving detection may refer to detection of unsafe driving behaviors that can create a dangerous driving environment. Unsafe driving behaviors are those driving behaviors that deviate compared to other drivers within a surrounding environment.

Generally, drivers drive their vehicles according to daily habits. However, driving variability is inevitable because drivers may adjust their driving behaviors based on a number of different environment conditions, such as but not limited to, vehicle type, geographic location, weather conditions, road conditions, etc. These adjustments need not be considered unsafe because the adjustments may be intentional due to changes in surrounding environmental conditions and driving conventions of the environment in which the driver is driving.

Conventionally, anomalous driving detection involved detection of unsafe driving behaviors by an ego vehicle. The ego vehicle monitors its driver (e.g., in cabin sensing and other sensor data of the ego vehicle) and detects unsafe driving behaviors, such as aggressive driving (e.g., speeding, agile or hastily executed maneuvers, etc.), distracted driving (e.g., swerving within a lane or between lanes, delayed reaction, etc.), and reckless driving (e.g., unstable following distances, unnecessary acceleration, etc.). The ego vehicle may also detect unsafe driving of other vehicles within proximity of the ego vehicle. Remote servers can collect data from the ego vehicle, as well as other vehicles, to train an anomalous driving detection model on anomalous driving behavior. Once trained, the anomalous driving detection model can be deployed, for example, to an ego vehicle for detecting anomalous driving behavior. Detection results can be used for controlling autonomous and semi-autonomous driving system to avoid or mitigate dangerous driving environments. In some examples, a semi-autonomous driving system may operate to guide a driver of a vehicle in a manner to reduce a risk of collision.

Conventionally, anomalous driving detection treated any and all unconventional driving behaviors equally as anomalous behavior indicative of unsafe driving. This can be a result of collecting data from vehicles in a multitude of different driving environments, such as, across varying geographic areas, across varying vehicle types, etc. The datasets used to train for anomalous driving detection did not differentiate between variations in environmental conditions. As such, anomalous driving detection model were trained to apply driving conventions uniformly to any detected behavior.

However, drivers tend to change driving behaviors based on differences in environmental conditions in which they are driving, such as but not limited to, vehicle type, geographic location, weather conditions, and combinations thereof. For instance, a driver may operate certain vehicle types with increased caution. As an illustrative example, a vehicle pulling a trailer may be driven at a slower speed than a vehicle without a trailer. Conversely, a sports car may be driven at a faster speed than a family vehicle. As another example, different driving behaviors may be warranted for different locations. For example, drivers located in a particularly one city or region may be more agile and thus a driver in that location may operate a vehicle with increased agility and haste, as compared to another city or region where drivers are less agile. As another example, a four-way stop may require stop-and-go driving where vehicles exhibit deviated following distance behavior that would otherwise be considered anomalous at another location (e.g., an expressway or highway with light traffic). In yet another example, different weather conditions may result in changes in driving behavior. For example, a driver driving a vehicle in snowy conditions may increase time headway/following distances or operate the vehicle at slower speeds. Windy conditions may cause a driver to swerve so to counter steer a vehicle and maintain position in a lane.

In the above examples, drivers may change their behavior in a way that conventional anomalous driving detection would classify as unsafe driving due to deviations from conventions reflected in the datasets used to train the anomalous driving detection model. That is, the anomalous driving detection model may have knowledge or training on variability in environmental conditions that can cause drivers to varying driving behaviors. As a result, an anomalous driving detection model may misclassify driving variabilities as unsafe or anomalous driving behavior, and trigger actions with an aim to induce safe driving and mitigate or avoid the unsafe driving behavior. Example actions may be, for example but not limited to, providing notifications to a driver that current driving behavior is considered unsafe and/or controlling an autonomous driving system to operate the vehicle according to what the model considers safe. However, because the driving variability was misclassified, the resulting actions may be counterproductive and may even lead to an unsafe driving behavior and increase exposure to locally dangerous conditions.

Accordingly, embodiments disclosed herein overcome the above shortcomings of conventional anomalous driving detection through hierarchical learning of driving variabilities, that can be applied to refine anomalous driving detection results. For example, a geographic area may be divided into a plurality of smaller geographic areas. Each of those smaller geographic areas may be further divided into even smaller geographic areas, thereby creating a hierarchical structure comprising plurality of levels. The lowest level of the hierarchical structure may be a vehicle layer, which comprises individual connected vehicles. The connected vehicles may transmit vehicle data (e.g., sensor data) to the next level of the hierarchical structure, which may comprise a plurality of managers implemented as computing devices or servers. These managers may transmit data vertically to managers at a next level of the hierarchical structure, as well as horizontally to another manager of the same level.

Each manager of the hierarchical structure may apply learning techniques to identify driving variabilities for environmental conditions within the corresponding geographic area. For example, each manager may aggregate vehicle data received from connected vehicles located in a corresponding geographic area and identify repetitive driving behaviors and contrasting driving behaviors for varying sets of environmental conditions within the corresponding geographic area. Repetitive driving behaviors may refer to driving behaviors that are repeatedly or regularly performed by vehicles under a set of environmental conditions. Contrasting driving behaviors may refer to driving behaviors that are irregularly performed (e.g., against or contrast from normalcy) or differ from behavior of other vehicles under a set of environmental conditions. A set of environmental conditions may refer to one or more of a certain geographic area, a certain weather condition, a certain vehicle type, or a combination thereof. The set of environmental conditions may also comprise of certain road conditions (e.g., construction; road type, such as but not limited to, dirt road, paved road; grade of road; etc.). The set of environmental conditions may also comprise seniority or experience of a driver with particular environmental conditions (e.g., a driver may have experience pulling a trailer); presence of a passenger (e.g., a driver may normally operate a vehicle agilely, and may alter this behavior if a baby is present in the vehicle); familiarity with particular environmental condition (e.g., a driver may be familiar with one geographic location and drive according to a first behavior, but change behaviors while driving an less familiar geographic area). The identified repetitive and contrasting driving behaviors may be unique to each manager of the hierarchical structure, as well as unique to each set of environmental conditions.

Once repetitive and contrasting driving behaviors are identified, they can be used to refine anomalous driving detection by filtering out driving variabilities from the anomalous driving detection results. Filtering out the driving variabilities, which may be those anomalous driving behaviors that may lead to safer driving environments, can provide only those detection results that are indicative of unsafe driving behavior for a certain set of environmental conditions. Embodiment disclosed herein detect driving variabilities by comparing repetitive driving behavior and contrasting driving behavior for a first set of environmental conditions against repetitive driving behavior and contrasting driving behavior for a second set of environmental conditions. The identified driving variabilities can be used to anomalous driving detection results from an anomalous driving model by filtering out (e.g., removing) driving variabilities from the anomalous detection results that are misclassified as anomalous driving behavior.

In an illustrative example, an ego vehicle may travel from the first set of environmental conditions to a second set of environmental conditions, such as, from a first geographic area to a second geographic area in an illustrative example. Upon entering the second set of environmental conditions, repetitive and contrasting driving behaviors may be obtained for the first set of environmental conditions from a manager corresponding to the first geographic area. In some example, the ego vehicle may obtain the repetitive and contrasting driving behaviors, while in another example, a manager corresponding to the second geographic area may obtain the repetitive and contrasting driving behaviors. The repetitive and contrasting driving behaviors for the first set of environmental conditions can be compared to the repetitive and contrasting driving behaviors for the second set of environmental conditions, either by the ego vehicle or the manager of the second set of environmental conditions. One or more driving variabilities can be identified from the comparison as a difference between the repetitive and contrasting driving behaviors of the second set of environmental conditions relative to those of the first set of environmental conditions. The one or more driving variables can then be supplied to an anomalous driving detection model to remove driving variabilities from the detection results.

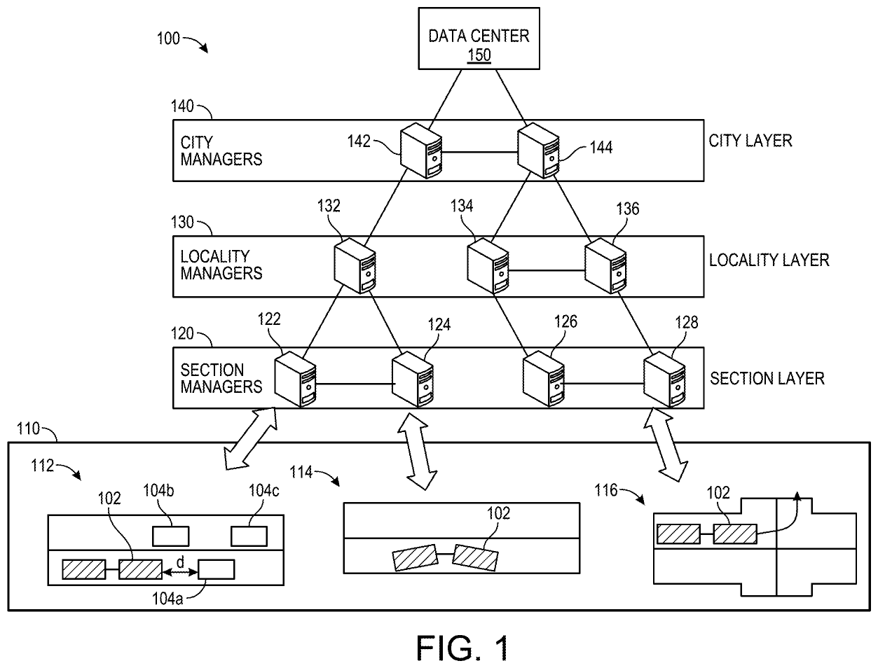

FIG. 1 is a schematic block diagram of an example hierarchical vehicular anomaly detection system 100 in accordance with embodiments disclosed herein. In embodiments, system 100 comprises a plurality of levels or layers of managers. For example, as shown in FIG. 1, the system 100 comprises a section layer 120, a locality layer 130, and a city layer 140. In addition, the system 100 also includes a vehicle layer 110 and a data center 150. In some examples, the system 100 may comprise more or less layers than that shown in FIG. 1.

The vehicle layer 110 comprises a plurality of vehicles, illustratively shown as vehicles 102 and 104a-104c. One or more of the vehicles of the vehicle layer 110 may be connected vehicles. The connected vehicles of the vehicle layer 110 may gather vehicle data and transmit the data to a section manager, as explained in further detail below. The gathered vehicle data may be data about the vehicle collecting the data, or data about other vehicles on the road. As vehicles drive along one or more roads, the vehicles may pass through different geographic areas that may be covered by different section managers. That is, each section manager may cover a different geographic area. Accordingly, as a connected vehicle drives along a road, the vehicle may gather vehicle data and transmit the data to the section manager that covers the section road or geographic area in which the vehicle is traveling (e.g., the closest section manager). Additional details regarding the vehicle layer 110 are discussed in further detail below.

The section layer 120 may include a plurality of section managers, for example, section managers 122, 124, 126, and 128. While the example of FIG. 1 shows the section layer 120 including four section managers, the section layer 120 may include any number of section managers. As discussed above, each section manager of the section layer 120 may cover (e.g., correspond to) a different geographic area. That is, for example, each section manager may receive vehicle data from one or more connected vehicles located in a corresponding geographic area. Vehicle data may be received as time series data. In the example of FIG. 1, the section managers 122, 124, 126, and 128 cover different areas of a next level of the hierarchical structure, as described below. Thus, in the example of FIG. 1, the section manager 122 receives vehicle data from vehicles 102 and 104a-104c while traveling in the geographic area covered by section manager 122, the section manager 124 receives vehicle data from vehicle 102 while traveling in the geographic area covered by section manager 124, and the section manager 128 receives vehicle data from the vehicle 102 traveling in the geographic area covered by section manager 128. More or fewer vehicles may be traveling in a covered area, which can supply vehicle data to a corresponding section manager.

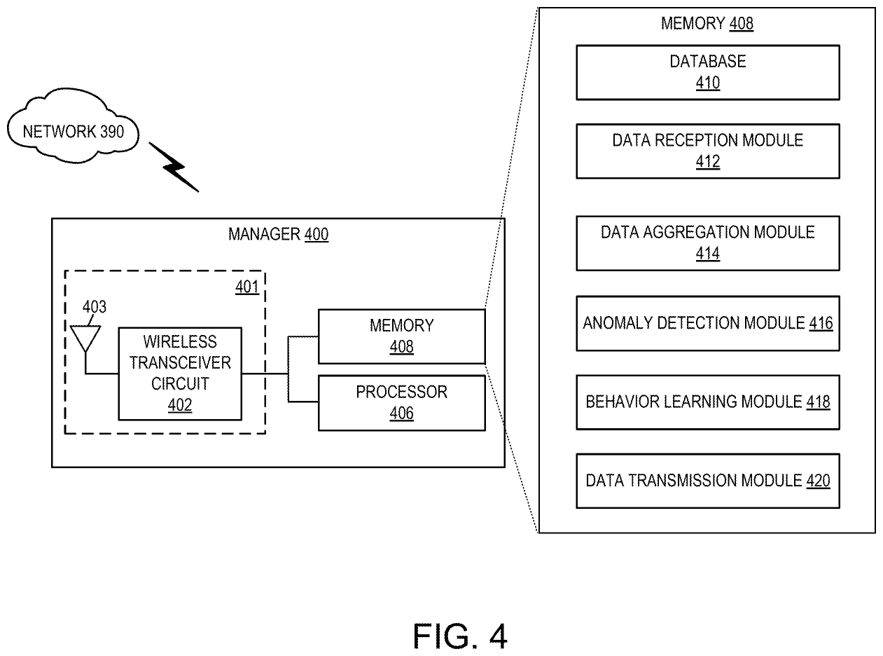

The section managers of the section layer 120 may be edge computing devices or edge servers, such as roadside units. As such, section managers (as well as other managers of FIG. 1) may be referred to herein as manager computing devices or manager servers. In one example, each section manager may be an edge server located near a road traveled by vehicles of the vehicle layer 110. In one example, one or more section managers of the section layer 120 may be hosted by a cloud server in a remote data center. After receiving vehicle data from one or more connected vehicles of the vehicle layer 110, a section manager may aggregate the received vehicle data and may transmit the aggregated data to a manager in a next higher level of the hierarchy, as described in further detail below. The section manager may also perform additional functionality described in further detail below with respect to FIG. 4.

In the example of FIG. 1, the next level is the locality layer 130. The locality level may include a plurality of locality managers, for example, locality managers 132, 134, and 136. While the example of FIG. 1 shows the locality layer 130 including three locality managers, the locality layer 130 may include any number of locality managers. Each locality manager of the locality layer 130 may cover a different geographic area. That is, each locality manager may receive section data from one or more section managers of the section layer 120 of a covered geographic area. In the example of FIG. 1, the locality manager 132 receives section data from section managers 122 and 124, the locality manager 134 receives section data from the section manager 126, and the locality manager 136 receives section data from the section manager 128. In the example of FIG. 1, each locality manager of the locality layer 130 covers a different portion of a city. As such, each locality manager covers a different geographic area or portion of a city, and each section manage covers a smaller geographic area of the geographic area of a corresponding locality manager. For example, section manager 122 may cover a first section of road included in the geographic area covered by locality manager 132, while section manager 124 covers a second section of road of the geographic area covered by locality manager 132.

The locality managers of the locality layer 130 may be edge computing devices, cloud-based computing devices, or other types of computing devices. After receiving section data from one or more section managers of the section layer 120, a locality manager may aggregate the received section data and may transmit the aggregated section data to a city manager in the city layer 140, as described in further detail below. The locality manager may also perform additional functionality described in further detail below with respect to FIG. 4.

The city layer 140 may include a plurality of city managers, for example, city managers 142 and 144. While the example of FIG. 1 shows the city layer 140 including two city managers, the city layer 140 may include any number of city managers. Each city manager of the city layer 140 may cover a different geographic area, such as a city. That is, each city manager may cover a geographic area that includes smaller geographic areas (e.g., localities) covered by locality managers of the locality layer 130. As such, each city manager may receive locality data from one or more locality managers of the locality layer 130. In the example of FIG. 1, the city manager 142 receives locality data from the locality managers 132 and 134 and the city manager 144 receives locality data from the locality manager 136. In the example of FIG. 1, each city manager of the city layer 140 covers a different city of a give state.

The city managers of the city layer 140 may be edge computing devices, cloud-based computing devices, or other types of computing devices. After receiving locality data from one or more locality managers of the locality layer 130, a city manager may aggregate the received locality data and may transmit the aggregated locality data to a the data center 150, as described in further detail below. The city manager may also perform additional functionality described in further detail below with respect to FIG. 4.

As alluded to above, system 100 may comprise of more or less layers than shown in FIG. 1. For example, one or more intermediate layers may be included between locality layer 130 and section layer 120 and/or between locality layer 130 and city layer 140. As another example, a higher layer may be included between data center 150 and city layer 140, such as a sub-national governmental layer. The sub-national governmental area layer may include one or more sub-national governmental area managers corresponding to a different geographic area, such as states, provinces, territories, and the like.

FIG. 1 also depicts vehicles in the vehicle layer 110 operated by drivers according to driving behaviors. In the example of FIG. 1, vehicle layer 110 depicts example driving behaviors 112, 114, and 116 as exhibited by vehicle 102 driving along sections of roads covered by a corresponding section manager of section layer 120. For example, driving behavior 112 depicts vehicle 102 traveling on a road covered by section manager 122, driving behavior 114 depicts vehicle 102 traveling on a road covered by section manager 124, and driving behavior 116 depicts vehicle 102 traveling on a road covered by section manager 128.

In each example, vehicle 102 is depicted as a vehicle pulling a trailer, which can be considered a vehicle type. In driving behavior 112, the vehicle 102 may be exhibiting cautious or conservative driving behavior by allowing for a larger following distance d relative to following distances exhibited by other surrounding vehicles. Vehicle 102 in driving behavior 112 may also be driving at a slower speed due to the increased load. Conventionally, the larger following distance or slower driving may be considered as indicative of anomalous driving behavior (e.g., distracted driving or potentially reckless). However, when the driving behavior is considered in view of environmental conditions, such as vehicle type in this example, the driving behavior may be indicative of a driving variability and not necessarily an anomalous driving behavior that can lead to unsafe driving conditions.

As another example, as depicted in driving behavior 114, the vehicle 102 may exhibit swerving behavior due to swerving within a lane. Conventionally, swerving may be indicative of anomalous driving, such as distracted driving or reckless driving. However, in the example of driving behavior 114, environmental conditions may include weather that causes the trailer and/or vehicle 102 to swerve, such as strong winds. In this case, when the considered in view of the environmental conditions, the driving behavior may be indicative of another driving variability aimed to counter environmental conditions through induced swerving to maintain control, and not necessarily an anomalous driving behavior.

Driving behavior 116 depicts another example in which vehicle 102 may exhibit an agile unprotected left turn. Conventionally, this type of driving may be indicative of anomalous driving, such as agile driving. However, when the driving behavior is considered in view of environmental conditions, such as a location where a traffic light has a short time duration in which the local norm is to perform agile and unprotected turns, the driving behavior may be indicative of a driving variability and not necessarily an anomalous driving behavior that can lead to unsafe driving conditions.

As another example, vehicle 102 may exhibit tailgating behaviors (e.g., short following distances between a lead vehicle), which can be conventionally considered agile driving. However, in a slow-moving, high density traffic situation, many drivers may tailgate other drivers simply because traffic is moving slowly enough that it is safe to do so. As such, tailgating may not be indicative of anomalous behavior. Similar situations arise at stop signs, where stop and go driving is not anomalous.

While certain examples are provided here, there are numerous other situations where driving variabilities are not necessarily indicative of anomalous driving.

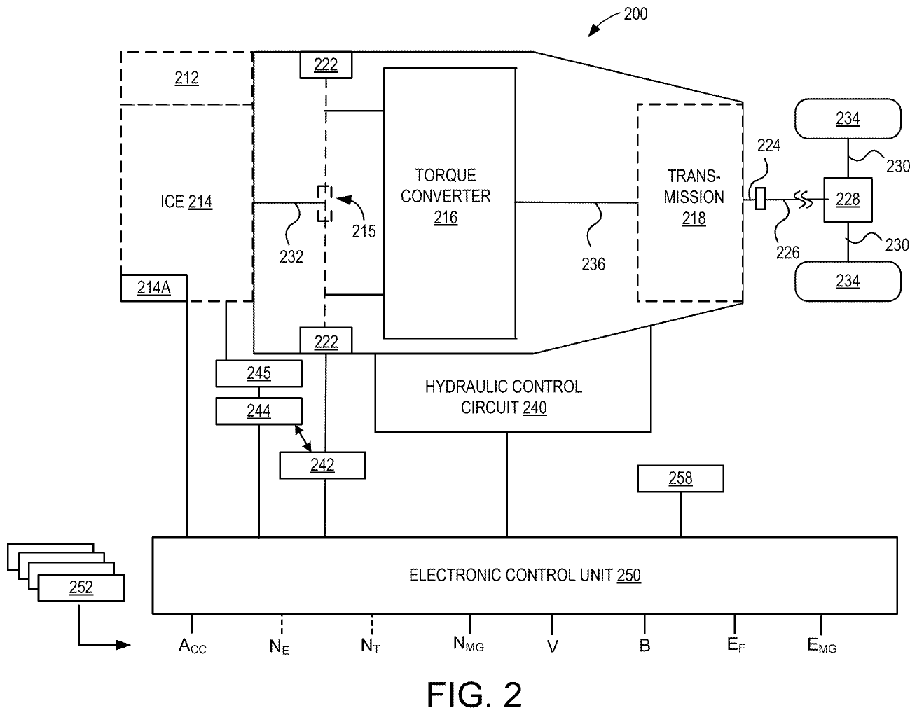

The systems and methods disclosed herein may be implemented with any number of different vehicles and vehicle types. For example, the systems and methods disclosed herein may be used with automobiles, trucks, motorcycles, recreational vehicles and others like on- or off-road vehicles. In addition, the principals disclosed herein may also extend to other vehicle types as well. An example hybrid electric vehicle (HEV) in which embodiments of the disclosed technology may be implemented is illustrated in FIG. 2, which may be implemented as any one or more of vehicles 102 and 104a-104c. Although the example described with reference to FIG. 2 is a hybrid type of vehicle, the systems and methods for anomalous driving detection can be implemented in other types of vehicle including gasoline- or diesel-powered vehicles, fuel-cell vehicles, electric vehicles, or other vehicles.

FIG. 2 illustrates a drive system of an example vehicle 200 that may include an internal combustion engine 214 and one or more electric motors 222 (which may also serve as generators) as sources of motive power. Driving force generated by the internal combustion engine 214 and motors 222 can be transmitted to one or more wheels 234 via a torque converter 216, a transmission 218, a differential gear device 228, and a pair of axles 230.

As an HEV, vehicle 200 may be driven/powered with either or both of engine 214 and the motor(s) 222 as the drive source for travel. For example, a first travel mode may be an engine-only travel mode that only uses internal combustion engine 214 as the source of motive power. A second travel mode may be an EV travel mode that only uses the motor(s) 222 as the source of motive power. A third travel mode may be an HEV travel mode that uses engine 214 and the motor(s) 222 as the sources of motive power. In the engine-only and HEV travel modes, vehicle 200 relies on the motive force generated at least by internal combustion engine 214, and a clutch 215 may be included to engage engine 214. In the EV travel mode, vehicle 200 is powered by the motive force generated by motor 222 while engine 214 may be stopped and clutch 215 disengaged.

Engine 214 can be an internal combustion engine such as a gasoline, diesel or similarly powered engine in which fuel is injected into and combusted in a combustion chamber. A cooling system 212 can be provided to cool the engine 214 such as, for example, by removing excess heat from engine 214. For example, cooling system 212 can be implemented to include a radiator, a water pump and a series of cooling channels. In operation, the water pump circulates coolant through the engine 214 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 214. In other applications, either or both the water pump and the fan may be operated by electric current such as from battery 244.

An output control circuit 214A may be provided to control drive (output torque) of engine 214. Output control circuit 214A may include a throttle actuator to control an electronic throttle valve that controls fuel injection, an ignition device that controls ignition timing, and the like. Output control circuit 214A may execute output control of engine 214 according to a command control signal(s) supplied from an electronic control unit 250, described below. Such output control can include, for example, throttle control, fuel injection control, and ignition timing control.

Motor 222 can also be used to provide motive power in vehicle 200 and is powered electrically via a battery 244. Battery 244 may be implemented as one or more batteries or other power storage devices including, for example, lead-acid batteries, nickel-metal hydride batteries, lithium ion batteries, capacitive storage devices, and so on. Battery 244 may be charged by a battery charger 245 that receives energy from internal combustion engine 214. For example, an alternator or generator may be coupled directly or indirectly to a drive shaft of internal combustion engine 214 to generate an electrical current as a result of the operation of internal combustion engine 214. A clutch can be included to engage/disengage the battery charger 245. Battery 244 may also be charged by motor 222 such as, for example, by regenerative braking or by coasting during which time motor 222 operate as generator.

Motor 222 can be powered by battery 244 to generate a motive force to move the vehicle and adjust vehicle speed. Motor 222 can also function as a generator to generate electrical power such as, for example, when coasting or braking. Battery 244 may also be used to power other electrical or electronic systems in the vehicle. Motor 222 may be connected to battery 244 via an inverter 242. Battery 244 can include, for example, one or more batteries, capacitive storage units, or other storage reservoirs suitable for storing electrical energy that can be used to power motor 222. When battery 244 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 250 (described below) may be included and may control the electric drive components of the vehicle, as well as other vehicle components. For example, electronic control unit 250 may control inverter 242, adjust driving current supplied to motor 222, and adjust the current received from motor 222 during regenerative coasting and breaking. As a more particular example, output torque of the motor 222 can be increased or decreased by electronic control unit 250 through the inverter 242.

A torque converter 216 can be included to control the application of power from engine 214 and motor 222 to transmission 218. Torque converter 216 can include a viscous fluid coupling that transfers rotational power from the motive power source to the driveshaft via the transmission. Torque converter 216 can include a conventional torque converter or a lockup torque converter. In other embodiments, a mechanical clutch can be used in place of torque converter 216.

Clutch 215 can be included to engage and disengage engine 214 from the drivetrain of the vehicle. In the illustrated example, a crankshaft 232, which is an output member of engine 214, may be selectively coupled to the motor 222 and torque converter 216 via clutch 215. Clutch 215 can be implemented as, for example, a multiple disc type hydraulic frictional engagement device whose engagement is controlled by an actuator such as a hydraulic actuator. Clutch 215 may be controlled such that its engagement state is complete engagement, slip engagement, and complete disengagement, depending on the pressure applied to the clutch. For example, a torque capacity of clutch 215 may be controlled according to the hydraulic pressure supplied from a hydraulic control circuit (not illustrated). When clutch 215 is engaged, power transmission is provided in the power transmission path between the crankshaft 232 and torque converter 216. On the other hand, when clutch 215 is disengaged, motive power from engine 214 is not delivered to the torque converter 216. In a slip engagement state, clutch 215 is engaged, and motive power is provided to torque converter 216 according to a torque capacity (transmission torque) of the clutch 215.

As alluded to above, vehicle 200 may include an electronic control unit 250. Electronic control unit 250 may include circuitry to control various aspects of the vehicle operation. Electronic control unit 250 may include, for example, a microcomputer that includes a one or more processing units (e.g., microprocessors), memory storage (e.g., RAM, ROM, etc.), and I/O devices. The processing units of electronic control unit 250, execute instructions stored in memory to control one or more electrical systems or subsystems 258 in the vehicle. Electronic control unit 250 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 2, electronic control unit 250 receives information from a plurality of sensors included in vehicle 200. For example, electronic control unit 250 may receive signals that indicate vehicle operating conditions or characteristics, or signals that can be used to derive vehicle operating conditions or characteristics. These may include, but are not limited to accelerator operation amount (A_{CC}), a revolution speed (N_{E}) of internal combustion engine 214 (engine RPM), a rotational speed (N_{MG}) of the motor 222 (motor rotational speed), and vehicle speed (N_{V}). These may also include torque converter 216 output (N_{T}) (e.g., output amps indicative of motor output), brake operation amount/pressure (B), and battery SOC (i.e., the charged amount for battery 244 detected by an SOC sensor). Accordingly, vehicle 200 can include a plurality of sensors 252 that can be used to detect various conditions internal or external to the vehicle, and provide sensed conditions to electronic control unit 250 (which, again, may be implemented as one or a plurality of individual control circuits). In one embodiment, sensors 252 may be included to detect one or more conditions directly or indirectly such as, for example, fuel efficiency (E_{F}), motor efficiency (E_{MG}), hybrid (internal combustion engine 214+MG 222) efficiency, acceleration (A_{CC}), etc.

In some embodiments, one or more of the sensors 252 may include their own processing capability to compute the results for additional information that can be provided to electronic control unit 250. In other embodiments, one or more sensors may be data-gathering-only sensors that provide only raw data to electronic control unit 250. In further embodiments, hybrid sensors may be included that provide a combination of raw data and processed data to electronic control unit 250. Sensors 252 may provide an analog output or a digital output.

Sensors 252 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 200, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those used to implement smart roadways that may actively transmit and/or receive data or other information.

The example of FIG. 2 is provided for illustration purposes only as one example of vehicle systems with which embodiments of the disclosed technology may be implemented. One of ordinary skill in the art reading this description will understand how the disclosed embodiments can be implemented with this and other vehicle platforms.

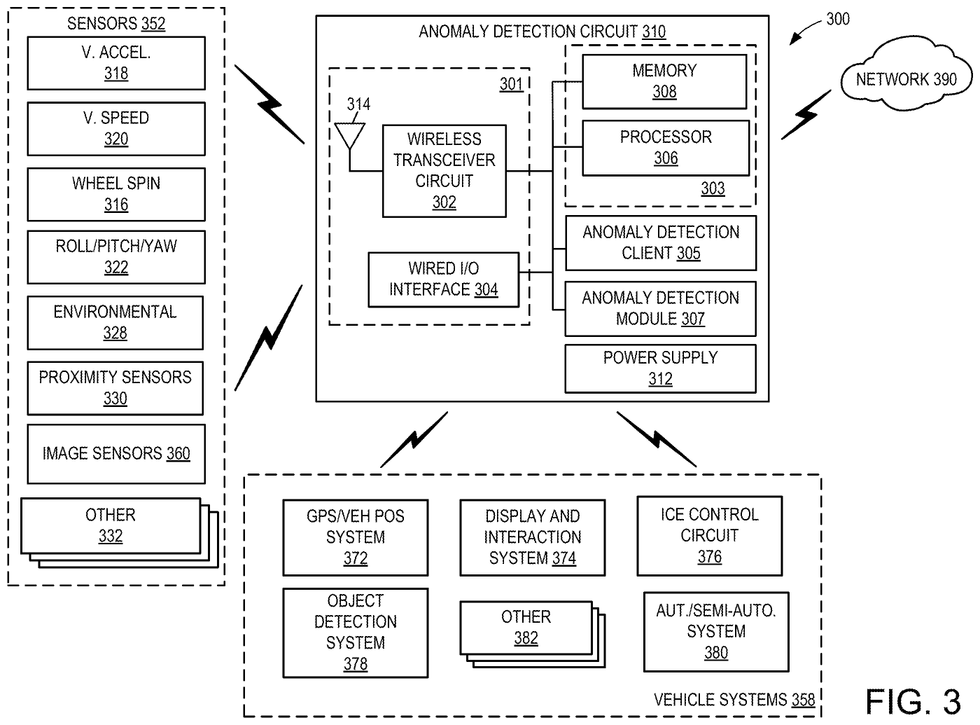

FIG. 3 illustrates an example architecture for anomalous driving detection in accordance with one embodiment of the systems and methods described herein. The anomalous driving detection, according to embodiment disclosed herein, can be refined through identification of driving variabilities.

Referring now to FIG. 3, in this example, anomalous driving detection system 300 includes an anomaly detection circuit 310, a plurality of sensors 352 and a plurality of vehicle systems 358. Sensors 352 (such as sensors 252 described in connection with FIG. 2) and vehicle systems 358 (such as subsystems 258 described in connection with FIG. 2) can communicate with anomaly detection circuit 310 via a wired or wireless communication interface. Although sensors 352 and vehicle systems 358 are depicted as communicating with anomaly detection circuit 310, they can also communicate with each other as well as with other vehicle systems. Anomaly detection circuit 310 can be implemented as an ECU or as part of an ECU such as, for example electronic control unit 250. In other embodiments, anomaly detection circuit 310 can be implemented independently of the ECU.

Anomaly detection circuit 310 in this example includes a communication circuit 301, a decision circuit 303 (including a processor 306 and memory 308 in this example) and a power supply 312. Components of anomaly detection circuit 310 are illustrated as communicating with each other via a data bus, although other communication in interfaces can be included. Anomaly detection circuit 310 in this example also includes an anomaly detection client 305 that can be operated to connect to an edge or cloud-based server of a network 390 to contribute to vehicle data for training models and/or download models to an anomaly detection module 307 for detecting on anomalous driving behavior for use by vehicle systems 358. For example, anomaly detection circuit 310 may collect vehicle data as sensor data from sensors 352 and/or vehicle systems 358 and communicate the vehicle data to servers (e.g., managers of FIG. 1) on network 390 via anomaly detection client 305. As another example, anomaly detection circuit 310 may download an anomaly detection model using anomaly detection client 305 via communication circuit 301 for storage and local deployment by anomaly detection module 307. The anomaly detection model may be deployed locally by anomaly detection circuit 310 on vehicle data collected by sensors 352 and/or vehicle systems 358 to detect anomalous driving behaviors and inform the detection results based on driving variabilities identified by the anomaly detection module 307. Examples of anomalous driving detection are provided, for example, in U.S. Pat. No. 11,414,088 and U.S. Pat. Pub. No. 2022/0375348, the disclosures of which are incorporated herein in their entirety.

Processor 306 can include one or more GPUs, CPUs, microprocessors, or any other suitable processing system. Processor 306 may include a single core or multicore processors. The memory 308 may include one or more various forms of memory or data storage (e.g., flash, RAM, etc.) that may be used to store instructions and variables for processor 306 as well as any other suitable information, such as, one or more of the following elements: vehicle data including sensor data and environmental condition data, along with other data as needed. Memory 308 can be made up of one or more modules of one or more different types of memory, and may be configured to store data and other information as well as operational instructions that may be used by the processor 306 to perform functions of anomaly detection circuit 310. In some examples, memory 308 may also store a vehicle identifier, such as a VIN.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up an anomaly detection circuit 310.

Communication circuit 301 includes either or both a wireless transceiver circuit 302 with an associated antenna 314 and a wired I/O interface 304 with an associated hardwired data port (not illustrated). Communication circuit 301 can provide for vehicle-to-everything (V2X) and/or vehicle-to-vehicle (V2V) communications capabilities, allowing anomaly detection circuit 310 to communicate with edge devices, such as roadside unit/equipment (RSU/RSE), network cloud servers and cloud-based databases, and/or other vehicles via network 390. For example, V2X communication capabilities allows anomaly detection circuit 310 to communicate with edge/cloud servers, roadside infrastructure (e.g., such as roadside equipment/roadside unit, which may be a vehicle-to-infrastructure (V2I)-enabled street light or cameras, for example), etc. Anomaly detection circuit 310 may also communicate with other connected vehicles over vehicle-to-vehicle (V2V) communications.

As this example illustrates, communications with anomaly detection circuit 310 can include either or both wired and wireless communications circuits 301. Wireless transceiver circuit 302 can include a transmitter and a receiver (not shown) to allow wireless communications via any number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by anomaly detection circuit 310 to/from other entities such as sensors 352 and vehicle systems 358.

Wired I/O interface 304 can include a transmitter and a receiver (not shown) for hardwired communications with other devices. For example, wired I/O interface 304 can provide a hardwired interface to other components, including sensors 352 and vehicle systems 358. Wired I/O interface 304 can communicate with other devices using Ethernet or any of a number of other wired communication protocols whether standardized, proprietary, open, point-to-point, networked or otherwise.

Power supply 312 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 352 can include, for example, sensors 252 such as those described above with reference to the example of FIG. 2. Sensors 352 can include additional sensors that may or may not otherwise be included on a standard vehicle with which the anomalous driving detection system 300 is implemented. In the illustrated example, sensors 352 include vehicle acceleration sensors 318, vehicle speed sensors 320, wheelspin sensors 316 (e.g., one for each wheel), accelerometers such as a 3-axis accelerometer 322 to detect roll, pitch and yaw of the vehicle, environmental sensors 328 (e.g., to detect salient or other environmental conditions), and proximity sensor 330 (e.g., sonar, radar, lidar or other vehicle proximity sensors) to detect conditions in an environment proximate to the vehicle. Additional sensors 332 can also be included as may be appropriate for a given implementation of system 300, such as vehicle-mounted mobile weather sensors, road condition and grade sensors, air quality sensors, etc.

System 300 may be equipped with one or more image sensors 360. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 360 can be used to, for example, to detect objects in an environment surrounding a vehicle comprising anomalous driving detection system 300, for example, surrounding vehicles, roadway environment, road lanes, road curvature, obstacles, and so on. For example, a one or more image sensors 360 may capture images of surrounding vehicles in the surrounding environment. As another example, object detection and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 360 may include cameras that may be used with and/or integrated with other proximity sensors 330 such as LIDAR sensors or any other sensors capable of capturing a distance. As used herein, a sensor set of a vehicle may refer to sensors 352.

Vehicle systems 358, for example, systems and subsystems 258 described above with reference to the example of FIG. 2, can include any of a number of different vehicle components or subsystems used to control or monitor various aspects of the vehicle and its performance. In this example, the vehicle systems 358 includes a vehicle positioning system 372 (e.g., a Global Positioning System or the like) that provides global coordinates or other position data of the vehicle; engine control circuits 376 to control the operation of engine (e.g., internal combustion engine 214 and/or motors 222); object detection system 378 to perform image processing such as object recognition and detection on images from image sensors 360, proximity estimation, for example, from image sensors 360 and/or proximity sensors, etc. for use in other vehicle systems; vehicle display and interaction system 374 (e.g., vehicle audio system for broadcasting notifications over one or more vehicle speakers), vehicle display system and/or the vehicle dashboard system), and other vehicle systems 382 (e.g., Advanced Driver-Assistance Systems (ADAS), autonomous or semi-autonomous driving systems 380, such as forward or rear collision detection and warning systems, pedestrian detection systems, autonomous or semi-autonomous driving systems), and the like.

Autonomous or semi-autonomous driving systems 380 can be operatively connected to the various vehicle systems 358 and/or individual components thereof. For example, autonomous or semi-autonomous driving systems 380 can send and/or receive information from the various vehicle systems 358 to control the movement, speed, maneuvering, heading, direction, etc. of the vehicle. The autonomous or semi-autonomous driving systems 380 may control some or all of these vehicle systems 358 and, thus, may be semi- or fully autonomous. According to some examples, anomalous driving detection results from anomaly detection module 307 may be communicated to autonomous or semi-autonomous driving systems 380 for autonomous or semi-autonomous operation of the vehicle in order to mitigate or avoid unsafe driving conditions. For example, autonomous or semi-autonomous driving systems 380 may receive anomalous driving detection results indicative of unsafe driving behavior or conditions and control the vehicle in a manner to mitigate unsafe driving. Mitigation may be in the form of a notification (e.g., visual, auditory, and/or haptic notifications or feedback) that are generated to notify the driving of unsafe driving conditions with an aim to induce corrective actions performed by the driver. In another example, autonomous driving operations may be performed by autonomous or semi-autonomous driving systems 380 to autonomously control the vehicle to mitigate unsafe driving conditions. In examples, a semi-autonomous system may operate to guide a driver of a vehicle in a manner to reduce a risk of collision.

Network 390 may be a conventional type of network, wired or wireless, and may have numerous different configurations including a star configuration, token ring configuration, or other configurations. Furthermore, the network 390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 390 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 8G-V2X or any other mobile data network or combination of mobile data networks. Further, the network 390 may include one or more IEEE 802.11 wireless networks.

In some embodiments, the network 390 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 8G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 8G; LTE-V2X; 8G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 8G-V2X message; and a millimeter wave message, etc.

During operation, anomaly detection circuit 310 can receive information, such as vehicle data, from various vehicle sensors 352 and/or vehicle systems 358. Communication circuit 301 can be used to transmit and receive information between anomaly detection circuit 310 and sensors 352, and anomaly detection circuit 310 and vehicle systems 158. Also, sensors 352 may communicate with vehicle systems 358 directly or indirectly (e.g., via communication circuit 301 or otherwise).

In various embodiments, communication circuit 301 can be configured to receive vehicle data and other information from sensors 352 that can be used in determining whether to mitigate anomalous driving behavior or not. Additionally, communication circuit 301 can be used to send an instruction signals to various vehicle systems 358 to act to mitigate anomalous driving behavior. For example, as described above, communication circuit 301 can be used to send instruction signals to autonomous or semi-autonomous driving systems 380 to mitigate anomalous driving behavior. The decision regarding what action to take via these autonomous or semi-autonomous driving systems 380 can be made based on the detection results by anomaly detection module 307.

In examples, communication circuit 301 can be also be configured to receive vehicle data and other information from remote devices. For example, communication circuit 301 may receive vehicle data and other information from one or more of: connected vehicles via V2V communications; from roadside equipment/roadside units via V2I communication; other Internet-of-Things devices via V2X communications, etc. In any case, the received information can be stored to memory 308 and can be used in determining whether to mitigate anomalous driving behavior or not, as described herein.

FIG. 4 is a schematic diagram of an example manager device 400, in accordance with embodiments of the disclosed technology. Manager device 400 may be implemented as any one of the managers discussed above in connection with FIG. 1. Thus, for example, manager device 400 may be an example section manager of the section layer 120, an example locality manager of the locality layer 130, or an example city manager of city layer 140. In this example, manager device 400 includes a communication circuit 401, a processor 406, and a memory 408. Manager device 400 may be implemented as an edger device or edge server, such as a road side unit, in some examples. In another example, manager device 400 may be implemented as a cloud server in a remote data center.

Processor 406 can include one or more GPUs, CPUs, microprocessors, or any other suitable processing system. Processor 406 may include a single core or multicore processors. The memory 408 may include one or more various forms of memory or data storage (e.g., flash, RAM, etc.) that may be used to store instructions and variables for processor 306 as well as any other suitable information, such as one or more of the following elements: vehicle data including sensor data and environmental condition data, along with other data as needed. Memory 308 can be made up of one or more modules of one or more different types of memory, and may be configured to store data and other information as well as operational instructions that may be used by the processor 406 to perform anomalous driving detection.

Although the example of FIG. 4 is illustrated using processor and memory circuitry, as described below with reference to circuits disclosed herein, manager device 400 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up manager device 400.

Communication circuit 401 includes a wireless transceiver circuit 402 with an associated antenna 403. Communication circuit 401 can provide for vehicle-to-everything (V2X) and/or vehicle-to-infrastructure (V2I) capabilities, allowing manager device 400 to communicate with connected vehicles via network 390. Communication circuit 401 can also provide network communication capabilities, allowing manager device 400 to communicate with other edge devices, such as other managers horizontally (e.g., within the same layer) or vertically (e.g., between layers) via network 390.

Wireless transceiver circuit 402 can include a transmitter and a receiver (not shown) to allow wireless communications via any of a number of communication protocols such as, for example, Bluetooth® communication, short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication, and mobile data protocol (e.g., 3G, 4G, 8G, LTE, LTE-V2V, LTE-V2I, LTE-V2X, LTE-D2D, VOLTE, 8G-V2X or any other mobile data protocols or combination of mobile data protocols). Antenna 403 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by manager device 400 to/from other entities other managers and/or connected vehicles.

The memory 408 may include a database 410, a data reception module 412, a data aggregation module 414, an anomaly detection module 416, a behavior learning module 418, and a data transmission module 420. Each of the database 410, the data reception module 412, the data aggregation module 414, the anomaly detection module 416, the behavior learning module 418, and the data transmission module 420 may be a program module in the form of operating systems, application program modules, and other program modules stored in one or more memory modules 404. In some embodiments, the program module may be stored in a remote storage device that may communicate with the manager device 400. Such a program module may include, but is not limited to, routines, subroutines, programs, objects, components, data structures and the like for performing specific tasks or executing specific data types as will be described below.

The database 410 may temporarily store data received from one or more connected vehicles of a vehicle layer (e.g., vehicle layer 110 of FIG. 1) or data received from another manager. The received data may include vehicle data, as described above in connection with FIG. 3. Data received from a horizontally situated manager (e.g., same layer) may include manage data, which may consist of vehicle data received by the horizontally situated manager related to vehicles covered by the horizontally situated manager. In another example, manager data received from a horizontally situated manager may include information indicative of repetitive driving behaviors and contrasting driving behaviors from an area covered by the horizontally situated manager. Manager data received from a lower layer manager may include vehicle data received from vehicles within a covered area, as well as repetitive driving behaviors and contrasting driving behavior of the covered area. Manager data received from a higher layer manager may include repetitive driving behaviors and contrasting driving behavior of an area covered by the higher layer manager, as well as indications that an anomaly has been detected in the form of anomalous driving detection results. Received data may be stored in database 410.

The data reception module 412 may receive manager data from one or more other managers and/or vehicle data (e.g., sensor data) from one or more connected vehicles of the vehicle layer 110. The vehicle data may be received directly from the vehicle layer 110, for example, in the case of a section manager. Vehicle data may also be received indirectly from the vehicle layer 110, for example, in the case of where vehicle data is received directly from either a vertically or a horizontally situated manager. The data reception module 412 may receive vehicle data from vehicles within a certain geographic area covered by the manager device 400, as discussed above. The received vehicle data may include sensor data captured by one or more connected vehicles indicating information about vehicles traveling with the covered geographic area (referred to herein as vehicle state information or vehicle state data). For example, the vehicle state data may include speeds, accelerations, and trajectories of the connected vehicle and other surrounding vehicles. In other examples, the vehicle data may include other information about vehicles.

The received vehicle data may also include sensor data captured by one or more connected vehicles indicating information about the environment in which the connected vehicles are traveling (referred to herein as environmental conditions information or environmental condition data). For example, the environmental condition data may include position data of the connected vehicles, vehicle type data (e.g., SUV, car, truck, pulling trailer, etc.), road condition data, and weather condition data of an environment in which the vehicle is traveling. In other examples, the environmental condition data may include other information about the environment.

The received vehicle data may also comprise a time stamp and a vehicle identifier (such as a VIN) associated therewith. The vehicle identifier and time stamp may be attributed to the original source of the data, such as the vehicle that detected or supplied the data, which may be connected or unconnected vehicle. The VIN may be used to identify a vehicle type in some cases, as well as associate received data with a particular vehicle. The time stamp may be used to coordinate vehicle data and environmental data in time.

In some examples, connected vehicles may form a group (e.g., a vehicular micro cloud), which can supply vehicle data to a connected ego vehicle. The ego vehicle can then communicate the vehicle data to a section manager corresponding to the geographic area in which the group is traveling. In this case, the ego vehicle may perform data aggregation functions as described below or upload raw vehicle data to the section manager, which then performs aggregation as described below. In another example, each connected vehicle uploads their respective vehicle data to a section manager.

The data aggregation module 414 may aggregate the received vehicle data. In one example, data aggregation module 414 may aggregate all of the received vehicle data together into a single aggregated group. While each individual vehicle of the vehicle layer 110 may only gather vehicle data about certain vehicles (e.g., nearby vehicles), by aggregating vehicle data from multiple vehicles in a covered geographic area, the manager device 400 may obtain a more comprehensive picture of vehicular activity within the section. For example, the data aggregation module 414 may aggregate received vehicle data and store the aggregated vehicle data in database 410 for determining driving behavior data.

In some examples, the data aggregation module 414 may aggregate the received environmental condition data and identify sets of environmental conditions from the received environmental condition data for the covered area of manager device 400. Each set of environmental conditions may include common environmental condition data, such as the covered area (or geographic area in which the vehicles are traveling) and one or more of the same weather condition, the same vehicle type, the same road conditions, and combinations thereof. Thus, each set of environmental conditions may define a particular environment experienced by vehicles traveling in the covered area. In some examples, manager device 400 may know the geographic area covered by the manager device 400, which may be used as an environmental condition data.

The data aggregation module 414 may split the vehicle state data according to the sets of environmental conditions and aggregate the vehicle state data into groups according to the sets of environmental conditions. For example, each vehicle state data can be associated with a set of environmental conditions using the VIN and/or time stamps of the vehicle data. As such, the vehicle state data can be grouped into different sets of environmental conditions, and aggregated with other vehicle state data of that group. The data aggregation module 414 may then determine driving behavior data for each set of environmental conditions from the aggregated vehicle state data.

The data aggregation module 414 may aggregate vehicle data such that manager device 400 can determine driving behavior data that no individual vehicle would be able to determine. For example, the data aggregation module 414 may aggregate received vehicle data and manager device 400 may determine one or more driving behaviors, for each set of environmental conditions, based on the received vehicle data. For example, the data aggregation module 414 may aggregate speeds of multiple vehicles of a certain set of environmental conditions to determine an average vehicle speed in a covered area for the set of environmental conditions; aggregate following distances of multiple vehicles (e.g., based on proximity sensor data) to determine average following distances and/or rate of change of following distances for the set of environmental conditions; aggregate trajectory data of multiple vehicles to determine swerving behaviors, agile turning behavior, abnormal or agile lane changes, etc. for the set of environmental conditions; and so on.

The anomaly detection module 416 may comprise an anomalous driving detection model trained to detect anomalous driving behaviors based on the received vehicle data. The anomalous driving detection model may be trained to determine the driving behavior data exhibited by vehicles based on vehicle data and identify anomalous driving behavior (e.g., anomalous driving detection results) from the driving behavior data. The anomalous driving detection results, which can be stored in database 410, refers to those driving behaviors that the anomaly detection module 416 determined to be unsafe driving behaviors that can create dangerous driving environments.

In some examples, the anomalous driving detection model may be trained at a remote data center (e.g., data center 150) by applying the vehicle data received from various managers, such as manager device 400, to an anomalous detection algorithm. In another example, the anomalous driving detection model may be trained at manager device 400 by applying the vehicle data of manager device 400 to an anomalous detection algorithm. In yet another example, the anomalous driving detection model may be trained by another manager device and obtained by manager device 400.

According to some examples, the anomalous driving detection model may be trained based on the vehicle data from across a multitude of environmental conditions (e.g., geographic area, vehicle type, weather conditions, etc.). As a result, the anomalous driving detection model can detect anomalous driving behaviors that deviate or diverge from driving conventions and norms across environmental conditions. In this case, the anomalous driving detection model may be trained using an aggregate of vehicle data received from any number of covered areas and generate an anomalous driving detection model.

In other examples, the anomalous driving detection model may be trained based on the vehicle data of a particular covered area, irrespective of other environmental conditions (e.g., vehicle type, weather conditions, etc.) within the covered area. Thus, the anomalous driving detection model can be trained to detect anomalous driving behaviors that deviate or diverge from driving conventions and norms within the covered area. In this case, the anomalous driving detection model may be trained by anomaly detection module 416 using an aggregate of vehicle data received from the covered area and generate an anomalous driving detection model for the particular covered area.

Once the anomalous driving detection model is trained, manager device 400 can upload the trained anomalous driving detection model to connected vehicles within the corresponding covered area. If the model was trained remotely from manager device 400, the manager device 400 may receive the model via data reception module 412 and then communicate the model to connected vehicles. The connected vehicles can then apply vehicle data to the model for detecting anomalous driving behavior surrounding the vehicle and taking actions, as described above, to mitigate unsafe driving behaviors. In another example, anomaly detection module 416 may receive vehicle data from one or more connected vehicles, apply the vehicle data to the anomalous driving detection model, and communicate anomalous driving detection results to connected vehicles within the covered area.

Examples of anomalous driving detection are provided, for example, in U.S. Pat. No. 11,414,088 and U.S. Pat. Pub. No. 2022/0375348, the disclosures of which are incorporated herein in their entirety.

However, simply looking at how a vehicle's driving behavior deviates from conventions drawn from a wide range of environmental conditions may not be sufficient to detect unsafe driving behaviors and dangerous driving environments. For example, tailgating may be a driving behavior indicative of an agile driver that could lead to a dangerous driving environment. However, in a high congestion, slow-moving traffic situation, many drivers may tailgate other drivers simply because traffic is moving slowly enough that it is safe to do so. Drivers tend to change driving behaviors based on multivariate environmental conditions in which they are driving. As such, simply looking at broad driving conventions may not be indicative of an actual anomaly.

Embodiments disclosed herein account for this variability across environmental condition by refining the anomalous driving detection results, determined by anomaly detection module 416, using driving variabilities for a particular covered area learned by the behavior learning module 418. For example, anomaly detection module 416 may cluster anomalous driving detection results according to sets of environmental conditions in which the driving behavior occurred and learn driving variabilities from the clusters for each set of environmental conditions. The learned driving variabilities may be referred to as driving variability data and stored in database 410. The driving variability data can be applied to the anomalous driving detection results to filter the driving variabilities from the anomalous driving detection results. As a result, the anomalous driving detection can be improved by distinguishing driving variabilities from actual unsafe driving behaviors according to environmental conditions.

Driving variability data may include one or more of the most frequently occurring repetitive driving behaviors for each set of environmental conditions. For example, behavior learning module 418 may use machine learning techniques or time series analysis techniques to learn repetitive driving behaviors from anomalous detection results for each set of environmental conditions. For example, the behavior learning module 418 may determine that certain anomalous driving behaviors are typically performed by drivers in a certain set of environmental conditions, based on the vehicle state data received over a period of time for the set of environmental conditions. The behavior learning module 418 may then add these learned repetitive driving behaviors to the database 410.

In some examples, behavior learning module 418 may identified the most frequently occurring repetitive driving behavior of each set of environmental conditions. For example, behavior learning module 418 may determine a number of occurrences (sometimes referred to herein as a number of events) of each learned repetitive driving behavior within a particular set of environmental conditions. Behavior learning module 418 can then rank the repetitive driving behaviors according to the number of events and identify the most frequently repetitive driving behavior. The identified most frequently repetitive driving behavior can be added to database 410. Learning of various repetitive driving behaviors, and identifying the most frequently occurring repetitive driving behavior can be performed for each set of environmental conditions.

Driving variability data may also include one or more of the most frequently occurring contrasting driving behavior for each set of environmental conditions. For example, behavior learning module 418 may use machine learning techniques or time series analysis techniques to learn contrasting driving behaviors from anomalous detection. For example, the behavior learning module 418 may determine that certain anomalous driving behaviors are irregularly or non-typically exhibited by drivers in a certain set of environmental conditions based on vehicle data received over a period of time for the set of environmental conditions. The behavior learning module 418 may then add these learned contrasting driving behaviors to the database 410.

In some examples, behavior learning module 418 may identify the most frequently occurring contrasting driving behavior of each set of environmental conditions. For example, behavior learning module 418 may determine a number of occurrences (sometimes referred to herein as a number of events) of each contrasting driving behavior within a set of environmental conditions. Behavior learning module 418 can then rank the contrasting driving behaviors according to the number of events and identify the most frequently contrasting driving behavior. The identified most frequently contrasting driving behavior can be added to database 410. Learning of the contrasting driving behaviors and identifying the most frequently occurring contrasting driving behavior can be performed for each set of environmental conditions.

In an example implementation, time series analysis can be executed on two types of driving behavior: normal and abnormal (including driving variability) driving behavior. The time series data of the two types of driving behavior can be compared and the contrasting driving behavior between normal and abnormal behavior can be inferred by behavior learning module 418. As another example, a machine learning model (e.g., transformers) can be trained, where a video frame of events about driving behavior is given as input, and the machine learning model infers the contrasting driving behavior. For repetitive driving behavior, the abnormal driving behaviors can be tagged according to actions taken during the behavior, such as braking, lane changing, etc., and pattern recognition algorithms (e.g., time series analysis or machine learning) can be used to infer the most frequent behaviors.

The repetitive and contrasting driving behaviors can be used to refine anomalous driving detection results. For example, behavior learning module 418 may compare its driving variability data for a first set of environmental conditions against driving variability data for a second set of environmental conditions and determine if a deviation exists between the driving variability data. The first and second set of environmental conditions may differ with respect to one or more environmental conditions (e.g., difference in one or more of vehicle type, weather condition, geographic area, etc.). If a deviation does exist between the compared driving variability data, behavior learning module 418 may identify the deviation as a driving variability between the first and second set of environmental conditions. The identified driving variability may then be applied to anomalous driving detection results to update the anomalous driving detection results. In an example, behavior learning module 418 may remove driving behaviors from the anomalous driving detection results based on the identified driving variability.

For example, a vehicle may travel between geographic regions that represent different environmental conditions. As a vehicle enters a geographic area covered by manager device 400, manager device 400 may receive data from a manager (referred to herein as manager data) corresponding to a geographic area in which the vehicle was previously. The manager data may include driving variability data of the sending manager. In this case, data reception module 412 may receive manager data from any manager, either vertically or horizontally. For example, the data reception module 412 may receive manager data from a manager that covers a geographic area different to the geographic area covered by the manager device 400, from a manager that covers a geographic area that includes the geographic area covered by the manager device 400, or from a manager that covers a geographic area that is included in the geographic area covered by the manager device 400. In an example with reference to FIG. 1, the section manager 124 may receive manager data from the section manager 122. As such, the section manager 122 may determine driving variability data for a first set of environmental conditions and transmit this as manager data to the section manager 124. The section manager 124 may determine driving variability data for a second set of environmental conditions and compare the received manager data to its driving variability data times to infer driving variabilities based on horizontal dependencies. In another example, the locality manager 132 may receive manager data from the section managers 122. The locality manager 132 may determine driving variability data for a second set of environmental conditions and compare its driving variability data to the manager data to infer driving variabilities based on vertical dependencies.

The data transmission module 420 may transmit information, such as manager data, from the manager device 400 to external devices, such as an anomaly detection circuit 310 on a vehicle or other managers. Manager device 400 may transmit manager data vertically to managers or vehicles of other levels of the hierarchical structure, as well as horizontally to other managers of the same level. In some examples, the manager data may include driving variability data as described above, which can be used by other managers or vehicles for updating anomalous driving detection results. In another example, manager data may include aggregated vehicle data for use by a receiving device. In yet another example, manager data may include an anomalous driving detection model, which can be provided to vehicles in the vehicle layer for detecting unsafe driving behaviors. As another example, manager data may include anomalous driving detection results, either prior to or subsequent to refinement based on driving variability data, which may be shared with vehicles in the vehicle layer for mitigating unsafe driving behaviors.

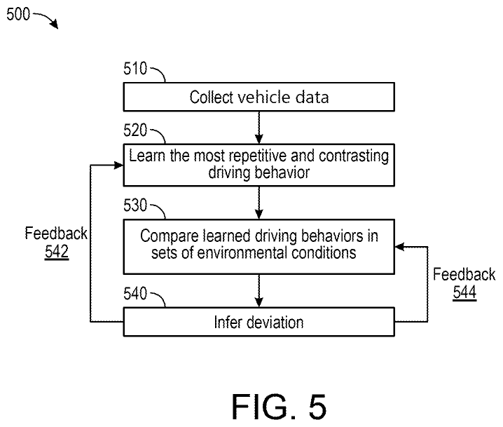

FIG. 5 is a flow chart illustrating example operations for identifying driving variabilities in accordance with various embodiments disclosed herein. Process 500 may be implemented as instructions, for example, stored on memory 408, that when executed by one or more processors perform one or more operations of process 500. In another example, process 500 may be implemented as instructions stored on anomaly detection circuit 310, that when executed by one or more processors to perform one or more operations of process 500. The process 500 will be described below with reference to FIGS. 3 and 4 as an illustrative example. However, one skilled in the art will appreciate that the embodiments disclosed herein are not to be limited to this implementation only. For example, while the following description will be made with reference to vehicular systems, the embodiments disclosed herein may be applied to other systems as desired.

At operation 510, vehicle data is collected. For example, vehicle data, such as sensor data from sensors 352 and/or vehicle systems 358, can be collected from one or more connected vehicles. In an example, manager device 400 may collect vehicle data of one or more connected vehicles via data reception module 412, as described above. The vehicle data may include vehicle state data and environmental data. The collected vehicle data may be aggregated and split according to sets of environmental conditions, as described above.

At operation 520, the most repetitive and contrasting driving behavior can be learned based on the collected vehicle data. The most repetitive and contrasting driving behavior may be stored as driving variability data according to environmental conditions, as described above in connection with FIG. 4. For example, as described above, behavior learning module 418 may use machine learning techniques or time series analysis techniques to learn repetitive and contrasting driving behaviors from anomalous driving detection results determined by anomaly detection module 416 for each set of environmental conditions. Behavior learning module 418 may then identified the most frequently occurring repetitive and contrasting driving behaviors for each set of environmental conditions.

Operations 510 and 520 may be performed by each manager of a hierarchical structure, as described in connection with FIG. 1. For example, section managers 122 may perform operations 510 and 520 to learn the most repetitive and contrasting driving behavior for each set of environmental conditions unique to the geographic area covered by section managers 122. Similarly, section managers 124, 126, and 128 learn the most repetitive and contrasting driving behavior for each set of environmental conditions unique to the geographic areas covered each respective section manager. Furthermore, each locality manager (e.g., locality managers 132-136) and city managers (e.g., city managers 142-144) learn the most repetitive and contrasting driving behavior for each set of environmental conditions unique to the geographic area covered by each respective manager.

At operation 530, learned repetitive and contrasting driving behaviors are compared for sets of environmental conditions. The sets of environmental conditions may be two sets of environmental conditions experienced by an ego vehicle, such that a second set of environmental conditions follows a first set of environmental conditions in time. In one example, the second set of environmental conditions may consecutive (e.g., immediately following) the first set of environmental conditions. In another example, one or more intermediate sets of environmental conditions may be between the first and second set. In various examples, the most frequently occurring repetitive and most frequently occurring contrasting driving behaviors are compared for sets of environmental conditions.

As an example, a vehicle may be travel from a first geographic area to a second geographic area. The first and second geographic areas may be covered by first and second managers, respectively. Upon entering the second geographic area, the second manager, which may be implemented as manager device 400, obtains learned first repetitive and contrasting driving behaviors from the first manager and compares the first repetitive and contrasting driving behaviors to its owned learned second repetitive and contrasting driving behaviors. The first and second managers maybe horizontally related (e.g., within the same level of the hierarchical structure) or vertically related (e.g., in different levels).

In another example, a single manager may compare repetitive and contrasting driving behaviors learned by the single manager for a first set of environmental conditions with those of a second set of environmental conditions learned by the same manager. This situation may occur, for example but not limited to, where weather conditions within a particular geographic area change, when a vehicle type changes within a particular geographic area, etc. As such, a single manager can identify driving variabilities within a common geographic area.

At operation 540, a deviation is inferred based on the comparison at operation 530. For example, as described above, manager device 400 can infer a deviation where the learned driving behaviors compared at operation 530 diverge from one another. The inferred deviation may be indicative of a driving variability between the sets of environmental conditions that were the basis for the comparison at operation 530.

Feedback loops 542 and 544 are provided for retraining of the machine learning models and improve the learning of repetitive and contrasting behaviors. Feedback loops 542 and 544 may gradually improve the machine learning models. For example, machine learning models learn repetitive and contrasting driving behaviors and filters them from the anomalous detect results. However, drivers may not like the how the vehicle operates upon filtering the repetitive and contrasting driving behaviors, and by interacting with the vehicle (e.g. pressing a input device, such as a button, a driver may indicate they don't like the results, not accepting guidance given by a autonomous/semi-autonomous system, or verbally explaining the situation) the driver can input their experience to the machine learning model as feedback. This allows the machine learning model to improve the learning of the driving variables and filter accordingly. For example, through feedback loops 544 and 542, process 500 can operate to change the underlying algorithm of the machine learning model and update the driving variability according to personal preferences. This can be achieved by changing the hyperparameters of the machine learning model to better capture the repetitive and contrasting driving behavior.

While the foregoing description is made with reference to operation 530 and 540 performed by a manager (e.g., manager device 400), embodiments disclosed herein are not intended to be so limited. For example, while the vehicle experiences a first set of environmental conditions, the vehicle may obtain the learned repetitive and contrasting driving behavior from a manager corresponding to the geographic area in which the vehicle is present. Upon entering a second set of environmental conditions, the vehicle may be supplied a second set of repetitive and contrasting driving behaviors for the manager of the geographic area in which the vehicle is present. The vehicle may then perform operations 530 and 540 to infer a deviation. The vehicle may perform feedback loop 544 and supply the inferred deviation and identify driving variability to the manager for executing feedback loop 542. In some embodiments, an ego vehicle may utilize the feedback loop 544 to better filter the learned repetitive and contrasting driving behavior according to a driver profile.

In an example implementation, operation 520 may be considered a training or learning phase of process 500. For example, operation 510 may collect vehicle data for a first time period to be used for training anomaly detection module 416 and behavior learning module 418. The vehicle data may be used to train the anomalous driving detection model to detect first anomalous driving detection results. The first anomalous detection results may be clustered according to sets of environmental data and applied to behavior learning module 418. For example, at operation 520, behavior learning module 418 may apply each cluster of anomalous driving detection results to machine learning techniques or time series analysis techniques to learn repetitive and contrasting driving behaviors from each cluster. The learned repetitive and contrasting driving behaviors can be associated with each set of environmental conditions according to the clusters. Once learned, the repetitive and contrasting driving behaviors may be stored as driving variability data.

In an example implementation, operations 530 and 540 may be considered run-time or deployment phases of process 500. For example, one or more vehicles may collect vehicle data for a second time period, which can be applied the trained anomaly detection model to detect a second anomalous driving detection results. The trained anomaly detection model may be on anomaly detection module 416, while in others the trained anomaly detection model may be deployed on one or more connected vehicles. In either case, in an illustrative example, an ego vehicle may travel from a first set of environmental conditions to a second set of environmental conditions. The second anomalous driving detection results may be detected from vehicle data collected in the second set of environmental conditions. Upon entering the second set of environmental conditions, operation 530 and operation 520 may be executed to identify a driving variability based on an inferred deviation. The identified driving variability can be applied to the second anomalous detection results to update the detection results, as described above.

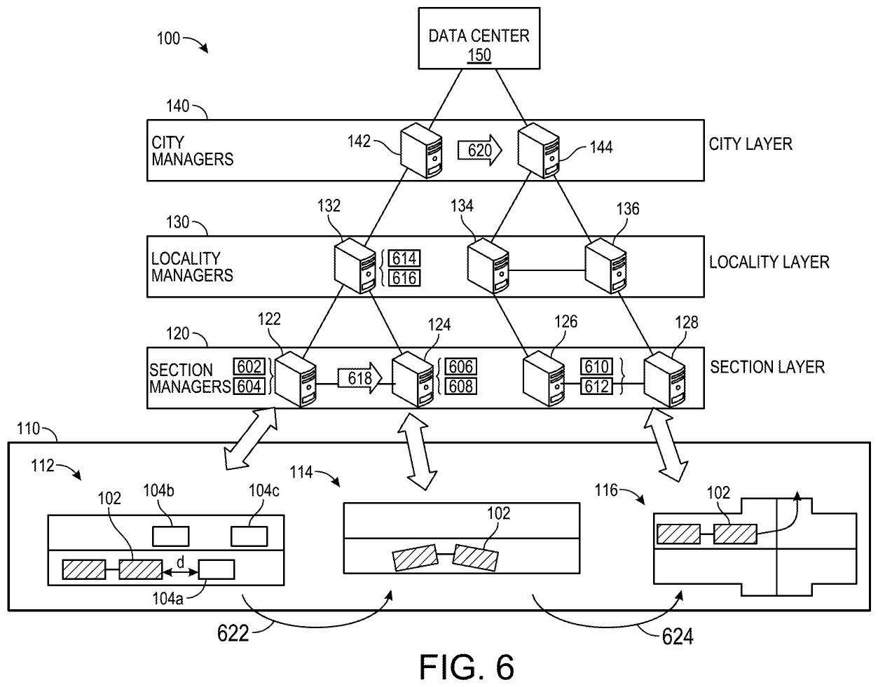

FIG. 6 depicts the hierarchical traffic management system 100 of FIG. 1 executed to identify driving variabilities in accordance with embodiments disclosed herein. FIG. 6 illustrates example implementations of anomalous driving detection according to embodiments disclosed herein under two scenarios. FIG. 6 depicts a first example scenario, in which vehicle 102 travels from a first geographic area, covered by section managers 122, to a second geographic area, covered by section manager 124 (illustratively shown by arrow 622). In this case, the vehicle 102 may travel from the first geographic area corresponding to section manager 124 to the second geographic area corresponding to section manager 124, such that the two geographic regions are consecutive (e.g., immediately following one another). A second example scenario is also provided in which vehicle 102 travels from the second geographic area to a third geographic area covered by section manager 128 (illustratively shown by arrow 624). In this case, the vehicle 102 may travel through one or more intermediate geographic regions.

In this example, each section manager 122-128, each locality manager 132-124, and each city manager 142-144 may be implemented as manager device 400. As such, each manager may learn the repetitive and contrasting driving behavior according to sets of environmental conditions for a respective covered area. For example, each manager may perform a training phase, such as operation 520 described above in connection with FIG. 5, during which the repetitive and contrasting driving behavior are determined. For example, as shown in FIG. 6, section managers 122 may learn repetitive driving behaviors 602 and contrasting driving behaviors 604, section manager 124 may learn repetitive driving behaviors 606 and contrasting driving behaviors 608, section manager 128 may learn repetitive driving behaviors 610 and contrasting driving behaviors 612, and locality manager 132 may learn repetitive driving behaviors 614 and contrasting driving behaviors 616.

Further, as described above, each manager may identify a most frequently occurring repetitive driving behavior and a most frequently occurring contrasting driving behavior from the respective repetitive and contrasting driving behavior. In the illustrative example of FIG. 6, section managers 122 may cover a first geographic area and an example first set of environmental conditions that includes the first geographic area, a type of vehicle towing a trailer, and weather conditions of negligible negative weather (e.g., little to no wind, no rain or snow, etc.). Section managers 122 may identify the most frequently occurring repetitive driving behaviors 602, for the first set of environmental conditions, to be that vehicles are centered in a lane with larger than normal following distances and identify the most frequently occurring contrasting driving behaviors 604 to be the vehicles perform agile and haste lane changes. Section manager 124 may cover a second geographic area and an example second set of environmental conditions includes the second geographic area, a type of vehicle towing a trailer, and weather conditions of strong winds. The most frequently occurring repetitive driving behaviors 606 for the second set of environmental conditions may be identified by section manager 124 as vehicles swerve slightly in the lane with larger than normal following distances and the most frequently occurring contrasting driving behaviors 608 identified may be vehicles perform agile and haste lane changes. City managers 142 may cover a first city with relatively light traffic congestion and patient drivers, while city managers 144 may cover a second city with relatively high traffic congestion and impatient drivers. Section manager 128 may cover a third geographic area in the second city and an example third set of environmental conditions includes the third geographic area, a type of vehicle towing a trailer, negligible negative weather, and high traffic congestion with impatient drivers. Section manager 128 may identify the most frequently occurring repetitive driving behaviors 610, for the third set of environmental conditions, to be that vehicles perform agile and hasty lane changes with smaller than normal following distances and identify the most frequently occurring contrasting driving behaviors 612 as vehicles swerve slightly inside a lane.

In the first example scenario, upon vehicle 102 traveling into the second geographic area from the first geographic area, section manager 124 may obtain repetitive driving behaviors 602 and contrasting driving behaviors 604 from section managers 122, illustratively depicted as communication 618. A deviation can be inferred by comparing repetitive driving behaviors 602 and contrasting behaviors 604 against repetitive driving behaviors 606 and contrasting driving behaviors 608, respectively. In this example, the contrasting driving behavior 608 is the same as the contrasting driving behavior 604 (e.g., agile lane changes). However, repetitive driving behaviors 602 and repetitive driving behaviors 610 differ in that vehicles remain in the center lane under the first set of environmental conditions, while vehicles swerve slightly under the second set of environmental conditions. This divergence can be inferred as a driving variability that centering a vehicle in a lane behavior deviates and diverges relative swerving in the second set of environmental conditions.

This knowledge, in the form of the inferred driving variability, can be used to improve anomalous driving detection results in the second geographic area. For example, when vehicle 102 enters the second geographic area, an anomaly detection model can be executed, by the vehicle 102 (e.g., anomaly detection circuit 310 installed in vehicle 102) or section managers 122 (e.g., implemented as manager device 400), to detect anomalous driving detection results based on vehicle data collected from one or more vehicles in the second geographic area. The inferred driving variability can then be applied to the anomalous driving detection results of the second geographic area and used to filter the results to account for driving variabilities. In the above example, the inferred driving variability can be applied to the anomaly detection model to filter anomalous driving behavior by removing driving behaviors that match swerving inside the lane behavior from detection results identified in the second geographic area.

In the second example scenario, upon vehicle 102 traveling into the third geographic area, from the second geographic area (e.g., to the second city from the first city), section manager 128 may obtain repetitive driving behaviors 606 and contrasting driving behaviors 608 via city manager 144 obtaining such information from city manager 142, illustratively depicted as communication 620. A deviation can be inferred based on comparing repetitive driving behaviors 606 and contrasting driving behaviors 608 against repetitive driving behaviors 610 and contrasting driving behaviors 612, respectively. In this case, deviations are present between repetitive driving behaviors 610 and repetitive driving behaviors 606, as well as between contrasting driving behaviors 608 and contrasting driving behaviors 612. From the inferred deviations, learned driving variabilities can be identified as vehicles exhibit larger following distance behavior and centering in a lane behavior in the second geographic area that deviates relative to short following distance behavior and agile lane changing behavior in the third geographic area.

This knowledge can be used in anomaly detection to filter anomalous driving detection results. For example, when vehicle 102 enters the third geographic area, an anomaly detection model can be executed, by the vehicle 102 or manager device 400, to detect anomalous driving detection results based on vehicle data collected from one or more vehicles in the third geographic area. The inferred driving variabilities can then be applied to the anomalous driving detection results and used to filter the results to account for driving variabilities. In the above examples, the inferred driving variabilities can be applied by removing driving behaviors from the detection results that match the agile lane change and short lane change behaviors from anomalous driving detection results, as identified in the third geographic area. Conversely, while in the second geographic area, the slight lane changing behavior may have been removed; however, this type of behavior may be reinstated as indicative of unsafe driving due to the difference in contrasting driving behaviors between the third and second set of environmental conditions.

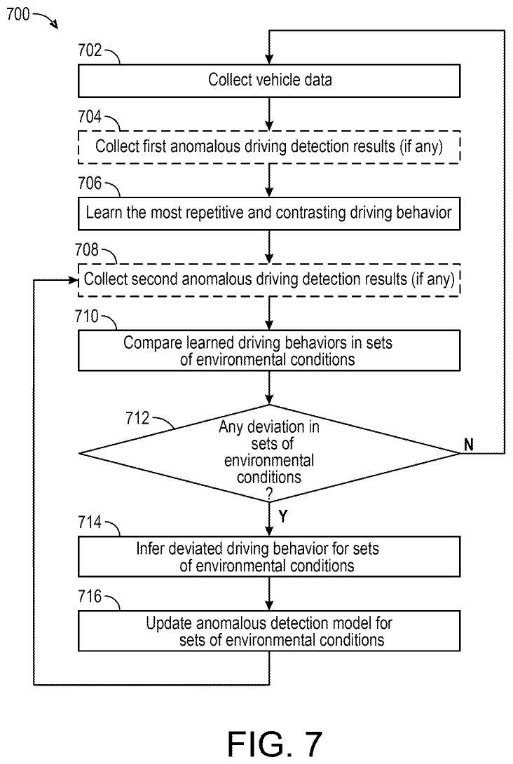

FIG. 7 is a flow chart illustrating example operations for detection anomalous driving behavior in accordance with various embodiments disclosed herein. Process 700 may be implemented as instructions, for example, stored on memory 408, that when executed by one or more processors, perform one or more operations of process 500. In another example, process 700 may be implemented as instructions stored on anomaly detection circuit 310, that when executed by one or more processors to perform one or more operations of process 700. The process 700 will be described below with reference to FIGS. 3 and 4 as an illustrative example. However, one skilled in the art will appreciate that the embodiments disclosed herein are not to be limited to this implementation only. For example, while the following description will be made with reference to vehicular systems, the embodiments disclosed herein may be applied to other systems as desired.

At operation 702, vehicle data is collected during a first time period. For example, vehicle data, such as sensor data from sensors 352 and/or vehicle systems 358, can be collected from one or more connected vehicles, as described above in connection with FIGS. 2-5. In an example, a manager device 400 may collect vehicle data of one or more connected vehicles via data reception module 412, as described above. The collected vehicle data may be aggregated and split according to sets of environmental conditions, as described above.

In some examples, as described above, a plurality of vehicles may form a vehicular micro cloud and share vehicle data throughout the vehicular micro cloud. An ego vehicle may then communicate the aggregated vehicle data to manager device 400. The ego vehicle may comprise anomaly detection circuit 310 of FIG. 3. In another example, each vehicle may communicate its vehicle data to the manager device 400 separately from other vehicles.

At optional operation 704, first anomalous driving detection results are collected (if any) based on the received vehicle data. For example, as described above, the vehicle data may be applied to a trained anomalous driving detection model that detects first anomalous driving detection results from the vehicle data. In some examples, the anomalous driving detection model may be executed by behavior learning module 418 of manager device 400. In another example, the anomalous driving detection model may be executed by anomaly detection module 307 of anomaly detection circuit 310, which can communicate the first anomalous driving detection results to manager device 400 via network 390.

At operation 706, the most repetitive and contrasting driving behavior can be learned from the vehicle data. The most repetitive and contrasting driving behavior may be stored as driving variability data according to environmental conditions, as described above in connection with FIG. 4. For example, as described above, a manager device 400 may use machine learning techniques or time series analysis techniques to learn repetitive and contrasting driving behaviors for each set of environmental conditions based on the vehicle data collected at operation 702. From the learned repetitive and contrasting driving behavior, the most frequently occurring repetitive and contrasting driving behaviors can be identified for each set of environmental conditions.

In an illustrative example, the first anomalous detection results may be clustered according to sets of environmental data. Each cluster of anomalous driving detection results can be applied, for example by behavior learning module 418, to machine learning techniques or time series analysis techniques, to learn repetitive and contrasting driving behaviors for each cluster. The learned repetitive and contrasting driving behaviors can be associated with each set of environmental conditions according to the clusters.

At optional operation 708, second anomalous driving detection results are collected (if any) based on vehicle data collected at a second time period after the first time period. For example, as described above, vehicle data may be collected upon an ego vehicle entering a second set of environmental conditions. The vehicle data may be collected, as describe above, from one or more connected vehicles including the ego vehicle, as described above in connection with FIGS. 2-5. The collected vehicle data may be applied to the trained anomalous driving detection model, which detects second anomalous driving detection results for the second set of environmental conditions. In an example, a manager device 400 corresponding to the second set of environmental conditions may collect and aggregate the vehicle data and determine the second anomalous driving detection results via anomaly detection module 416. In another example, the anomaly detection circuit 310 of the ego vehicle may collect and aggregate the vehicle data and execute anomaly detection module 307 to determine the second anomalous driving detection results from the anomalous driving detection model.

At operation 710, learned repetitive and contrasting driving behaviors of sets of environmental conditions are compared. For example, as described above in connection with FIGS. 4-6, the ego vehicle may have traveled from a first set of environmental conditions to the second set of environmental conditions. The driving variability data (e.g., learned repetitive and contrasting driving behaviors) for the second set of environmental conditions can be compared to those of the first environmental conditions. The comparison may be performed by manager device 400 (e.g., behavior learning module 418) or by the anomaly detection circuit 310 of the ego vehicle (e.g., anomaly detection module 307). In either case, manager device 400 first obtains driving variability data for the first set of environmental conditions from its own database (e.g., where the first and second set of environmental conditions correspond to the same geographic area) or from another manager (e.g., where the first and second set of environmental conditions correspond to different geographic areas). If the comparison is performed at anomaly detection circuit 310 of the ego vehicle, manager device 400 transmits the first driving variability data as well as the second driving variability data for the second set of environmental conditions to anomaly detection circuit 310. The driving variability data may be used by manager device 400 and/or the anomaly detection circuit 310 to update the anomalous driving detection model by filtering the detection results according to inferred deviations between the first and second driving variability data.

At operation 712, a determination is made as to whether deviations exist between the learned driving behaviors. For example, based on the comparison at operation 710, operation 712 determines if the second driving variability data deviates from the second driving variability data. If there no deviations are present, the process 700 returns to operation 702 and repeats for a next set of environmental conditions. If, however, the determination is affirmative, the process proceeds. Examples of affirmative determinations are provided above in connection with FIG. 6.

At operation 714, deviated driving behavior is inferred for the sets of environmental conditions based on the determination at operation 712. For example, as described above in connection with FIGS. 4-6, a deviation can be inferred where repetitive driving behavior of the second set of environmental conditions differs (e.g., deviates) from the repetitive driving behavior of the first set of environmental conditions. As another example, a deviation can be inferred where contrasting driving behavior of the second set of environmental conditions differs (e.g., deviates) from the contrasting driving behavior of the first set of environmental conditions. Operation 714 may be performed by a manager device 400 corresponding to the second set of environmental conditions and communicated to anomaly detection circuit 310 or performed by the anomaly detection circuit 310 itself. Thus, one or more deviations can be inferred at operation 714, which can be indicative of driving variabilities between the sets of environmental conditions.

At operation 716, the anomalous driving detection model can be updated based on the inferred deviation. For example, any inferred deviations can be used as knowledge of shifts in driving variabilities between the sets of environmental conditions. The driving variabilities may be indicative of a change in driving behavior that is considered safe or unsafe in the second set of environmental conditions, for example, as described above in connection with FIG. 6. This knowledge can be supplied to the anomalous driving detection model, either on the manager device 400 or anomaly detection circuit 310 of the ego vehicle, and the anomalous driving detection results can be filtered accordingly. Thus, anomalous driving behavior corresponding to driving variabilities in the form of repetitive driving behaviors for a particular set of environmental conditions can be removed from the anomalous driving detection results. Whereas, contrasting driving behaviors for the particular set of environmental conditions can be added back to the driving detection results, for example, where this behavior was considered safe for a previous set of environmental conditions.

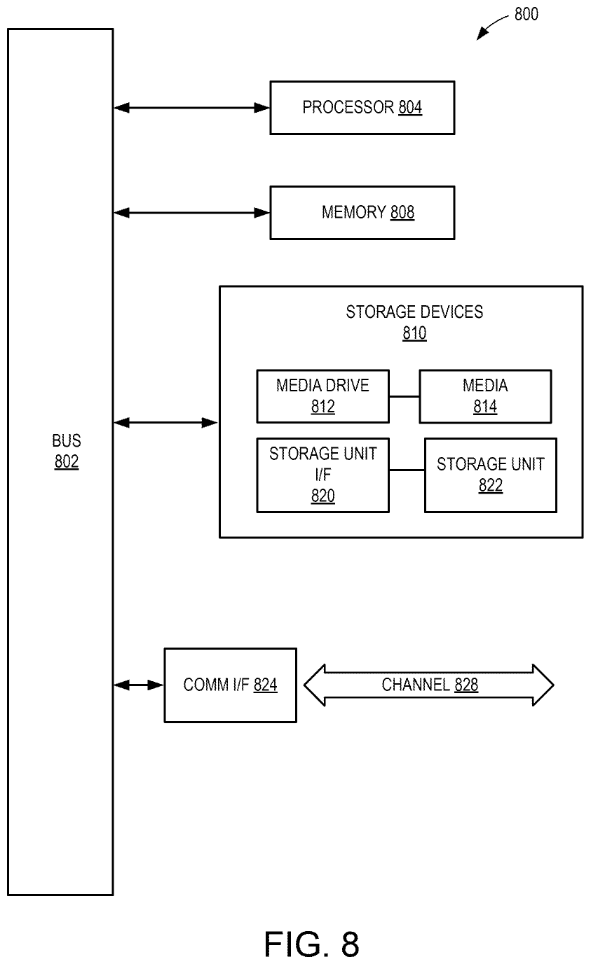

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various embodiments are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. This can include a processor, and/or any one or more of the components making up system 300 of FIG. 3 and/or manager device 400 of FIG. 4. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 may store instructions to be executed by processor 804 for performing operations of process 500 of FIG. 5 and/or process 700 of FIG. 7. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
collecting first vehicle data of driving behavior of vehicles in a first set of environmental conditions;
identifying first repetitive driving behavior and first contrasting driving behavior with respect to driving behavior in the first set of environmental conditions based on the first vehicle data;
collecting second vehicle data of driving behavior of vehicles in a second set of environmental conditions;
identifying second repetitive driving behavior and second contrasting driving behavior with respect to driving behavior in the second set of environmental conditions based on the second vehicle data;
detecting one or more driving variabilities by comparing the second repetitive driving behavior and second contrasting driving behavior to the first repetitive driving behavior and first contrasting driving behavior to identify deviated driving behavior; and
updating first anomalous driving detection results from an anomalous driving detection model based on the detected driving variabilities.

2. The method of claim 1, further comprising:
controlling a vehicle in the second set of environmental conditions based on the updated first anomalous driving detection results.

3. The method of claim 1, wherein the first and second sets of environmental conditions comprises one or more of: a vehicle type, a geographic area, a weather condition, and a road condition.

4. The method of claim 1, further comprising:
detecting second anomalous driving detection results from the anomalous driving detection model based on the first vehicle data; and
determining a plurality of repetitive driving behaviors and a plurality of contrasting driving behaviors based on second anomalous driving detection results.

5. The method of claim 4, further comprising:
identifying a most frequently occurring repetitive driving behavior as the first repetitive driving behavior; and
identifying a most frequently occurring contrasting driving behavior as the first contrasting driving behavior.

6. The method of claim 1, further comprising:
detecting the first anomalous driving detection results from the anomalous driving detection model based on third vehicle data of driving behavior of at least an ego vehicle in the second set of environmental conditions,
wherein detecting the one or more driving variabilities is based on the ego vehicle traveling from the first set of environmental conditions to the second set of environmental conditions.

7. The method of claim 1, wherein updating the anomalous driving detection results comprises:
removing at least one of the first anomalous driving detection results based on the detected driving variabilities.

8. The method of claim 1, wherein identifying the first repetitive driving behavior and the first contrasting driving behavior comprises:
using one or more of machine learning and time series analysis to determine the first repetitive driving behavior and the first contrasting driving behavior based on the first vehicle data.

9. The method of claim 1, further comprising:
obtaining, by a second computing device, the first repetitive driving behavior and first contrasting driving behavior from a first computing device, wherein the first computing device is associated with a first geographic area of the first set of environmental conditions,
wherein the second computing device detects the one or more driving variabilities, and wherein the second set of environmental conditions comprises a second geographic area.

10. The method of claim 9, where the second computing device is associated with the second geographic area.

11. A hierarchical vehicular anomaly detection system, comprising:
one or more manager devices, each manager device being associated with a certain geographic area; and
an ego vehicle communicable connected to the one or more manager devices,
wherein the one or more manager devices is configured to execute instructions to:
collect first vehicle data of driving behavior of vehicles in a first set of environmental conditions;
identify first repetitive driving behavior and first contrasting driving behavior with respect to driving behavior in the first set of environmental conditions based on the first vehicle data;
collect second vehicle data of driving behavior of vehicles in a second set of environmental conditions; and
identify second repetitive driving behavior and second contrasting driving behavior with respect to driving behavior in the second set of environmental conditions based on the second vehicle data,
wherein one of the ego vehicle and the one or more manager devices is configured to execute instructions to:
detect one or more driving variabilities by comparing the second repetitive driving behavior and second contrasting driving behavior to the first repetitive driving behavior and first contrasting driving behavior to identify deviated driving behavior; and
update first anomalous driving detection results from an anomalous driving detection model based on the detected driving variabilities.

12. The hierarchical vehicular anomaly detection system of claim 11, wherein the first and second sets of environmental conditions comprises one or more of: a vehicle type, a geographic area, a weather condition, and a road condition.

13. The hierarchical vehicular anomaly detection system of claim 11, wherein the one or more manager devices is further configured to execute instructions to:
detect second anomalous driving detection results from the anomalous driving detection model based on the first vehicle data; and
determine a plurality of repetitive driving behaviors and a plurality of contrasting driving behaviors based on second anomalous driving detection results.

14. The hierarchical vehicular anomaly detection system of claim 13, wherein the one or more manager devices is further configured to execute instructions to:
identify a most frequently occurring repetitive driving behavior as the first repetitive driving behavior; and
identify a most frequently occurring contrasting driving behavior as the first contrasting driving behavior.

15. The hierarchical vehicular anomaly detection system of claim 11, wherein the one of the ego vehicle and the one or more manager devices is further configured to execute instructions to:
detect the first anomalous driving detection results from the anomalous driving detection model based on third vehicle data of driving behavior of at least an ego vehicle in the second set of environmental conditions,
wherein detecting the one or more driving variabilities is based on the ego vehicle traveling from the first set of environmental conditions to the second set of environmental conditions.

16. The hierarchical vehicular anomaly detection system of claim 11, wherein updating the anomalous driving detection results comprises:
removing at least one of the first anomalous driving detection results based on the detected driving variabilities.

17. The hierarchical vehicular anomaly detection system of claim 11, wherein identifying the first repetitive driving behavior and the first contrasting driving behavior comprises:
using one or more of machine learning and time series analysis to determine the first repetitive driving behavior and the first contrasting driving behavior based on the first vehicle data.

18. The hierarchical vehicular anomaly detection system of claim 11, wherein the one or more manager devices is further configured to execute instructions to:
obtain, by a second manager of the one or more manager devices, the first repetitive driving behavior and first contrasting driving behavior from a first computing device, wherein the first computing device is associated with a first geographic area of the first set of environmental conditions,
wherein the second computing device detects the one or more driving variabilities, and wherein the second set of environmental conditions comprises a second geographic area.

19. The hierarchical vehicular anomaly detection system of claim 18, where the second computing device is associated with the second geographic area.

20. A server, comprising:
a memory storing instructions; and
at least one processor communicably coupled to the memory and configured to execute the instructions to:
detect a vehicle in a first set of environmental conditions, the first set of environmental conditions comprising a first geographic area associated with the server;
obtain first driving variability data for the first set of environmental conditions, the first driving variability data based on vehicle data of driving behavior of vehicles in the first set of environmental condition;
obtain second driving variability data for a second set of environmental conditions that differ from the first set of environmental conditions, the second driving variability data based on vehicle data of driving behavior of vehicles in the second set of environmental condition;
identify one or more driving variabilities based on a comparison between the first and second driving variability data; and
operate the vehicle based on the identified one or more driving variabilities.
